(19) United States
(12) Patent Application Publication
(10) Pub. No.: US 2023/0064058 A1
(43) Pub. Date: Mar. 2, 2023

(54) TERMINATION PANEL WITH PIVOTING ADAPTER BULKHEAD SECTIONS

(71) Applicant: CommScope Technologies LLC, Hickory, NC (US)

(72) Inventors: Arend J. Turner, Minnetrista, MN (US); Matthew J. Holmberg, Le Center, MN (US); Rodney C. SCHOENFELDER, Shakopee, MN (US)

(21) Appl. No.: 17/822,976

(22) Filed: Aug. 29, 2022

Related U.S. Application Data
(60) Provisional application No. 63/237,807, filed on Aug. 27, 2021.

(51) Int. Cl. G02B 6/44; G02B 6/38

(52) U.S. Cl. CPC G02B 6/4452; G02B 6/3897

(57) ABSTRACT

A termination panel includes a termination bulkhead formed of multiple pivoting bulkhead members. Each bulkhead member is configured to selectively pivot about a pivot axis extending through a middle region of the bulkhead member. The bulkhead members may pivot independent of each other or may entrain pivoting motion of adjacent bulkhead members. In certain examples, the location of the pivot axis about which the bulkhead members pivot can be changed without changing the bulkhead members.

### CROSS-REFERENCE TO RELATED APPLICATIONS

This application claims the benefit of U.S. Provisional Patent Application No. 63/237,807, filed Aug. 27, 2021. The disclosure of the priority application in its entirety is hereby incorporated by reference into the presence application.

### BACKGROUND

Communication systems utilize fiber optic cables to connect together pieces of equipment (e.g., telecommunications equipment). Equipment panels are used to optically couple fiber optic cables to cross-connect between various types of communications equipment. The demand for added capacity is growing rapidly. This demand is being met in part by the increasing use and density of fiber optic transmission equipment. Even though fiber optic equipment permits higher levels of transmission in the same or smaller footprint than traditional copper transmission equipment, the demand requires even higher levels of fiber density. In environments of higher fiber density, access, cleaning, and repair all can pose challenges.

Further development in such higher density fiber systems is desired.

### SUMMARY

Some aspects of the disclosure are directed to a termination panel including pivoting bulkhead members. In certain examples, each bulkhead member pivots about a common pivot rod extending across the termination panel.

In some implementations, each bulkhead member is configured to pivot about a pivot rod extending through a middle of a length of the bulkhead member. In certain examples, pivotal movement of opposite ends of the bulkhead member is limited by first and second retention strips.

In other implementations, each bulkhead member is configured to pivot about a pivot rod extending through a first end of the length of the bulkhead member. In certain implementations, each bulkhead member is configured to selectively receive two or more pivot rods. In certain examples, an example termination panel is configured to enable movement of two or more pivot rods between extended and retracted positions to facilitate engagement and disengagement with the bulkhead members.

In some implementations, the bulkhead members are configured to pivot independent of each other. In other implementations, the bulkhead members are configured so that pivotal movement of one bulkhead member automatically transfers an opposite pivotal movement to an adjacent bulkhead member. In certain implementations, the bulkhead members are configured so that pivoting of a first group of bulkhead members in a first direction automatically pivots a second group of bulkhead members in a second opposite direction. In certain examples, the bulkhead members of the first and second groups are interspersed (e.g., alternating).

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a first example implementation of a termination panel including multiple bulkhead members mounted to a chassis and configured in accordance with the principles of the present disclosure;

FIG. 2 is a side elevational view of the termination panel of FIG. 1 with a first side wall removed for ease in viewing an interior of the termination panel;

FIG. 3 is a front perspective view of a portion of the termination panel of FIG. 1 with the bulkhead members disposed in neutral positions;

FIG. 4 shows one of the bulkhead members of FIG. 3 arranged in a first angled position;

FIG. 5 shows one of the bulkhead members of FIG. 3 arranged in a second angled position;

FIG. 6 shows a first of the bulkhead members of FIG. 3 arranged in a first angled position, second and third bulkhead members arranged in neutral positions, and a fourth bulkhead member arranged in a second angled position;

FIG. 7 is a top plan view of the termination panel of FIG. 3 with the surrounding chassis walls removed for ease in viewing;

FIG. 8 is a front perspective view of an example implementation of a bulkhead member configured in accordance with the principles of the present disclosure;

FIG. 9 shows port members exploded outwardly from the bulkhead member of FIG. 8;

FIG. 10 is an enlarged view of a portion of the first retention strip and first end portions of a first bulkhead member disposed in the first angled position and another bulkhead member disposed in the neutral position;

FIG. 11 is an enlarged view of a portion of the second retention strip and second end portions of the bulkhead members of FIG. 10;

FIG. 12 is a perspective view of another example implementation of a bulkhead member suitable for holding port members and being mounted within the chassis of FIG. 1;

FIG. 13 is a perspective view of yet another example implementation of a bulkhead member suitable for holding port members and being mounted within the chassis of FIG. 1;

FIG. 14 shows first and second joining members exploded away from opposite sides of the bulkhead member of FIG. 13;

FIG. 15 shows the joining members and bulkhead member of FIG. 14 assembled together;

FIG. 16 is a front perspective view of an example termination panel including bulkhead members configured to be moved in groups of two or more bulkhead members;

FIG. 17 is a rear perspective view of the termination panel of FIG. 16;

FIG. 18 is an enlarged view of a portion of FIG. 17;

FIG. 19 is a front perspective view of another example termination panel having multiple movable pivot rods about which the bulkhead members can pivot;

FIG. 20 is a rear perspective view of an example bulkhead member suitable for use with the termination panel of FIG. 19;

FIG. 21 is a side elevational view of the bulkhead member of FIG. 20 showing a bulkhead member pivoting about a middle pivot rod between a neutral and angled position;

FIG. 22 is a side elevational view of the bulkhead member of FIG. 20 showing a bulkhead member pivoting about a lower pivot rod between a neutral and angled position;

FIG. 23 is a side elevational view of the bulkhead member of FIG. 20 showing a bulkhead member pivoting about an upper pivot rod between a neutral and angled position;

FIG. 24 is a perspective view of the termination panel of FIG. 19 with a first bulkhead member pivoted to a first angled position about the middle pivot rod while the upper and lower pivot rods are disposed in retracted positions;

FIG. 25 shows the termination panel of FIG. 19 with the middle pivot rod retracted and the upper pivot rod moved to an extended position; and

FIG. 26 shows a first bulkhead member of the termination panel of FIG.

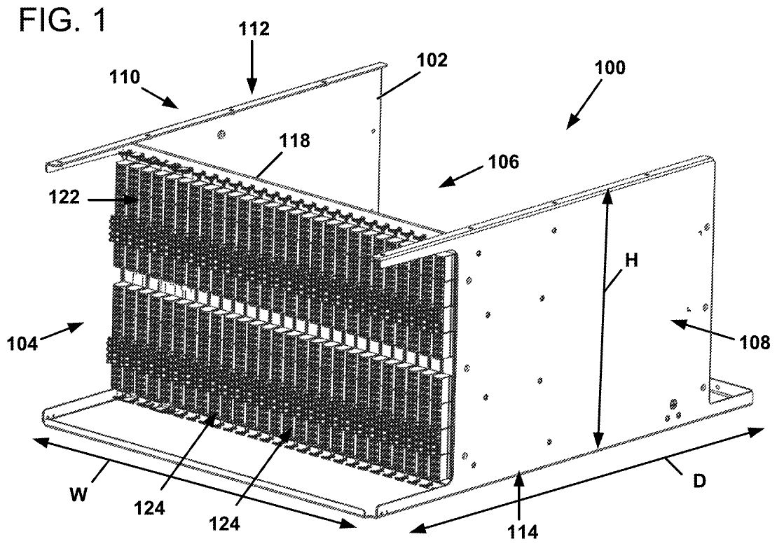

25 pivoted to a second angled position about the upper pivot rod.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A termination panel 100, 200 includes a chassis 102, 202 having a depth D extending between a front 104 and a rear 106, a width W extending between opposite first and second sides 108, 110, and a height H extending between a top 112 and a bottom 114. The chassis 102, 202 defines a framework opening 116 bounded by oppositely facing first and second retainer strips 118, 120. One or more bulkhead members 124 are mounted at the framework opening 116 to define a termination bulkhead 122 having front-facing ports 126 and rear-facing ports 128. In certain examples, the front- and rear-facing ports 126, 128 are defined by optical adapters 130 carried by the bulkhead members 124.

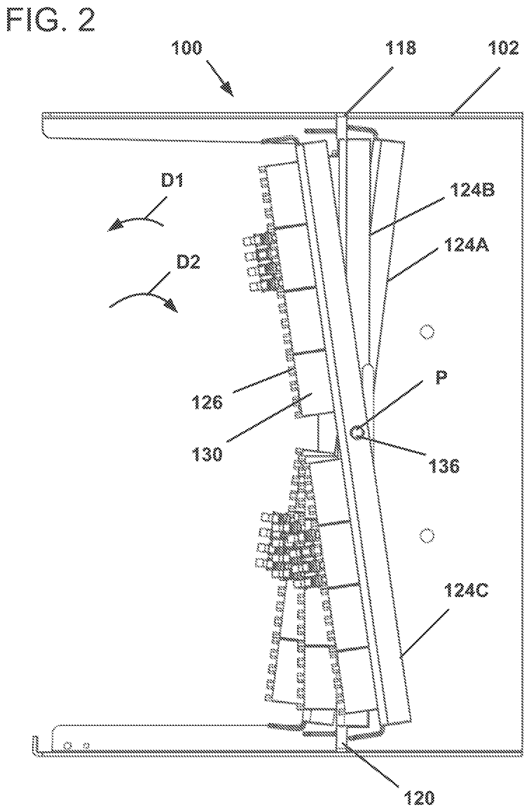

Each bulkhead member 124 is pivotal about a pivot axis P relative to the chassis 102 to provide enhanced access to at least some of the front-facing ports 126. As shown in FIG. 2, each bulkhead member 124 is movable about the pivot axis P in a first direction D1 between a neutral position (see bulkhead member 124B) to a first angled position (see bulkhead member 124C). In certain implementations, each bulkhead member 124 is movable about the pivot axis P in a second direction D2 between the neutral position to a second angled position (see bulkhead member 124A). In certain examples, the second direction D2 is rotationally opposite the first direction D1.

In some implementations, the first retainer strip 118 is disposed at a top of the framework opening 116 and the second retainer strip 120 is disposed at a bottom of the framework opening 116. In such examples, a pivot rod 136 extends horizontally between the first and second sides 108, 110 of the chassis 102 to define a horizontal pivot axis P. Each bulkhead member 124 rotates about the horizontal pivot axis P so that forward-facing ports 126 at the top 112 or bottom 114 of the framework opening 116 are selectively moved forwardly. In other implementations, the first retainer strip 118 is disposed at the first side 108 of the framework opening 116 and the second retainer strip 120 is disposed at the second side 110 of the framework opening 116. In such examples, the pivot rod 136 extends vertically between the top and bottom 112, 114 of the chassis 102 to define a vertical pivot axis P. Each bulkhead member 124 rotates about the vertical pivot axis P so that forward-facing ports 126 at the first side 108 or the second side 110 of the framework opening 116 are selectively moved forwardly. For convenience, the pivot rod 136 is shown extending horizontally in the figures.

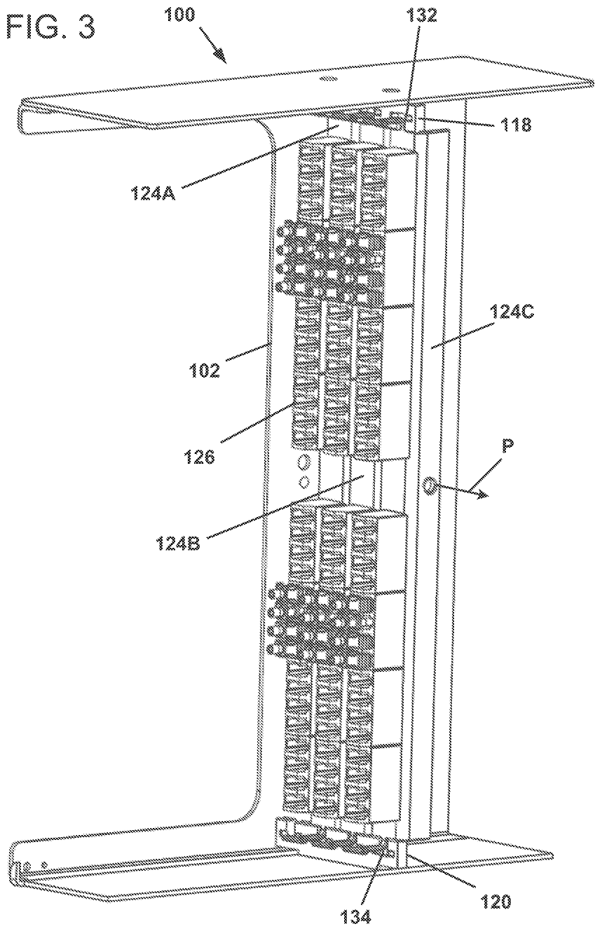

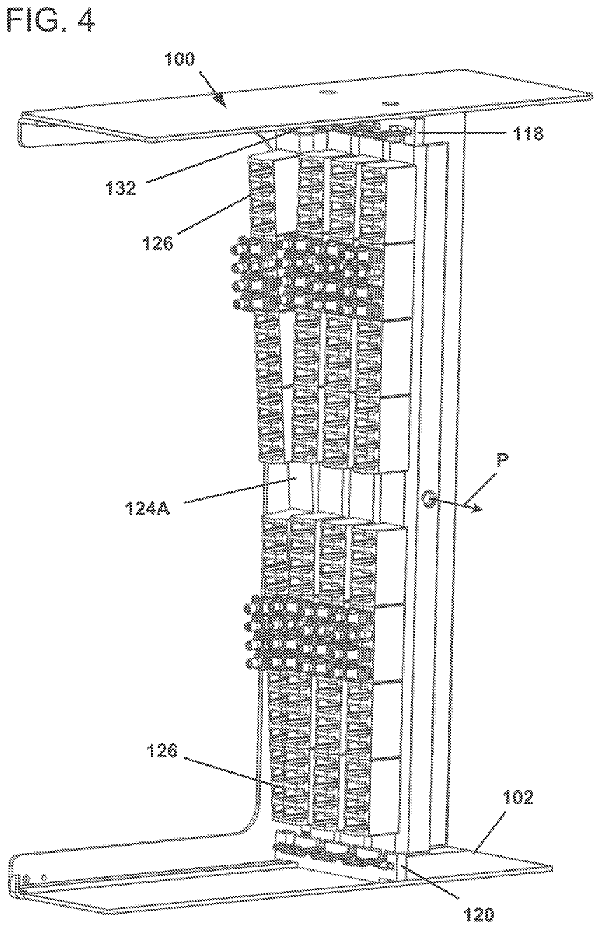

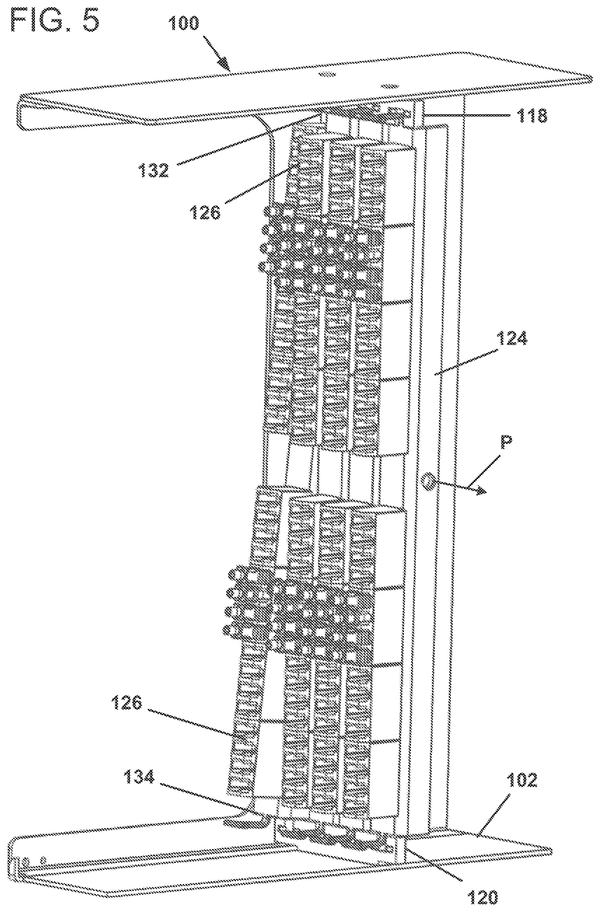

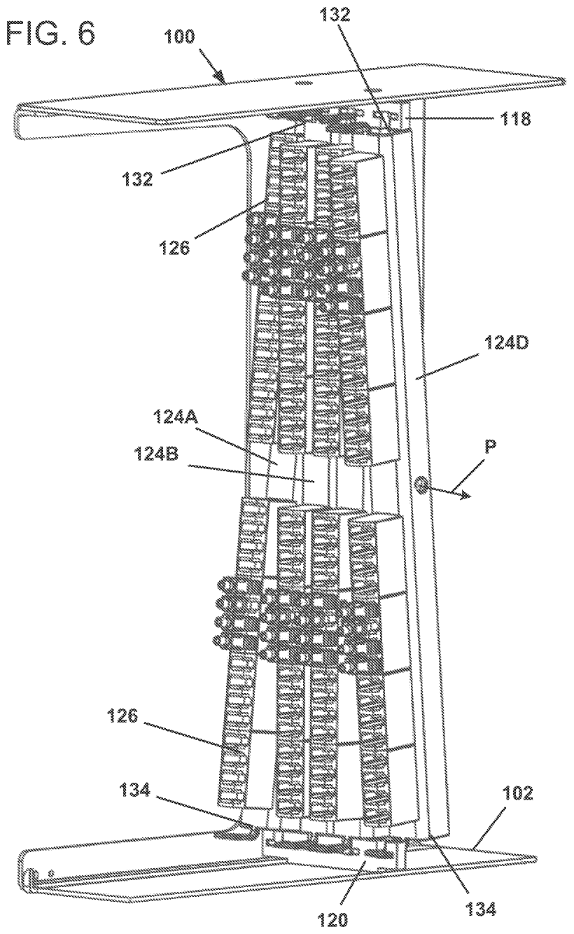

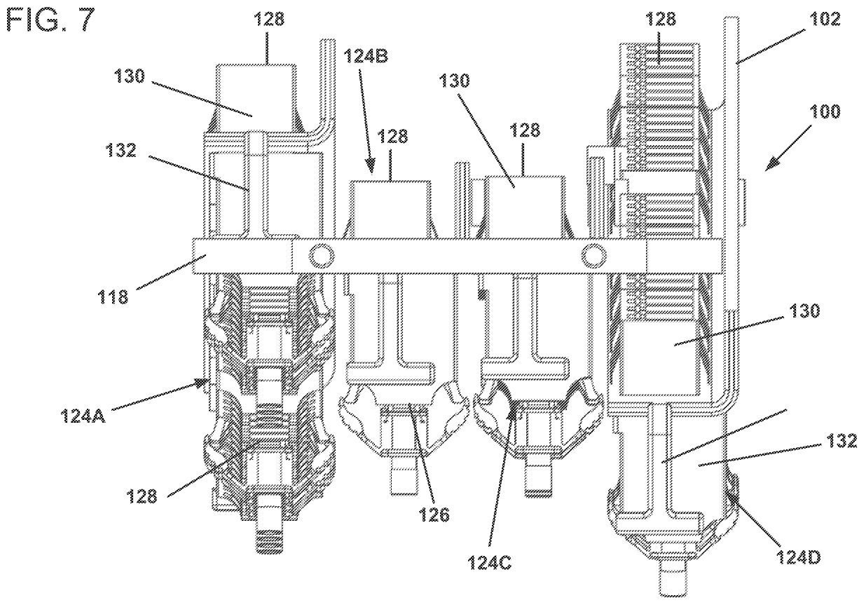

For example, FIG. 3 shows part of a chassis 102 with three bulkhead members 124A, 124B, 124C each disposed in the neutral position. In FIG. 4, the first bulkhead member 124A is disposed in the first angled position while the other bulkhead members remain in the neutral position. In FIG. 5, the first bulkhead member 124A is disposed in the second angled position while the other bulkhead members remain in the neutral position. In FIGS. 6 and 7, the first bulkhead member 124A is disposed in the second angled position, the second bulkhead member 124B is disposed in the neutral position, and a fourth bulkhead member 124D is disposed in the first angled position.

Pivoting a bulkhead member 124 to one of the angled positions provides better hand access to one or more of the forward-facing ports 126 and/or to one or more of the rearward-facing ports 128. In some examples, pivoting the bulkhead member 124A to the first angled position (e.g., see FIG. 4) provides enhanced hand access to forward-facing ports 126 disposed at the top of the bulkhead member 124A. In certain examples, disposing the bulkhead member 124A in the first angled position also provides enhanced hand access to the forward-facing ports 126 disposed at the bottom of adjacent bulkhead members (e.g., bulkhead member 124B in FIG. 4). In certain examples, hand access to at least the top-most forward-facing ports 126 of the first bulkhead member 124A can be further enhanced by pivoting the second bulkhead member 124B to the second angled position, thereby moving the top-most forward-facing ports 126 of the second bulkhead member 124B rearward relative to the top-most forward-facing ports 126 of the first bulkhead member 124A.

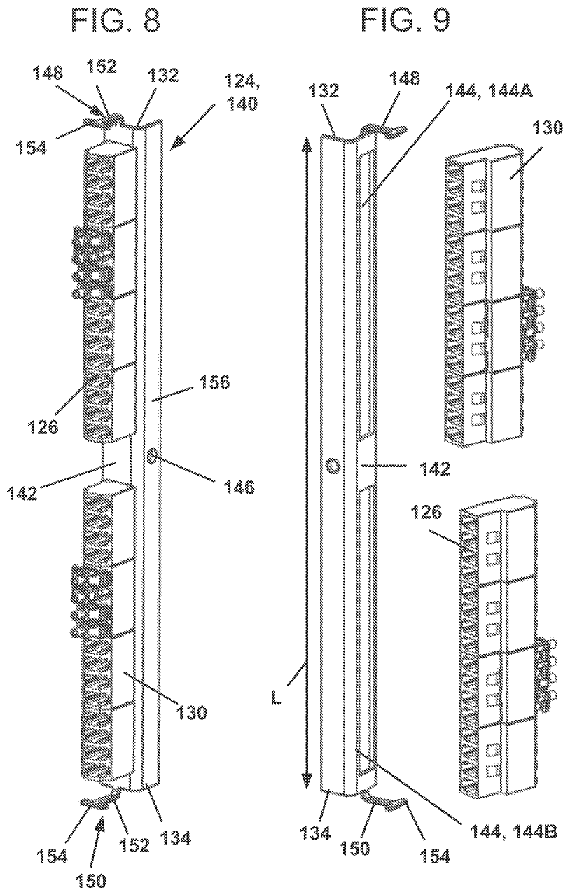

FIGS. 8 and 9 illustrate one example implementation 140 of a bulkhead member 124. The illustrated bulkhead member 140 includes a front surface 142 extending along a length L between opposite first and second ends 132, 134. Each bulkhead member 140 defines a pivot aperture 146 at an intermediate location along the length L. The pivot aperture 146 is sized to receive the pivot rod 136 of the chassis 102.

Each front surface 142 defines at least one aperture 144 at which one or more port members (e.g., one or more optical adapters 130) can be disposed. In the example shown, the front surface 142 defines a first aperture 144A and a second aperture 144B disposed at opposite ends of the aperture 144. In such an example, a port member is not disposed at the pivot region of the bulkhead member 124 (i.e., the region that would move the least along the depth D of the chassis 102 during movement of the bulkhead member 124).

Each bulkhead member 124 including a first retainer 148 at the first end 132 and a second retainer 150 at the second end 134 of the bulkhead member 124. The first retainer 148 forming a first handle at the first end 132 by which the bulkhead member 124 can be pivoted. The second retainer 150 forms a second handle at the second end 134 by which the bulkhead member 124 can be pivoted. Each of the first and second retainers 148, 150 includes an arm 152 extending outwardly from the respective end 132, 134 of the bulkhead member 124. In certain examples, each of the first and second retainers 148, 150 also includes a cross-member 154 disposed at a free end of the arm 152. In an example, the first and second retainers 148, 150 are T-shaped.

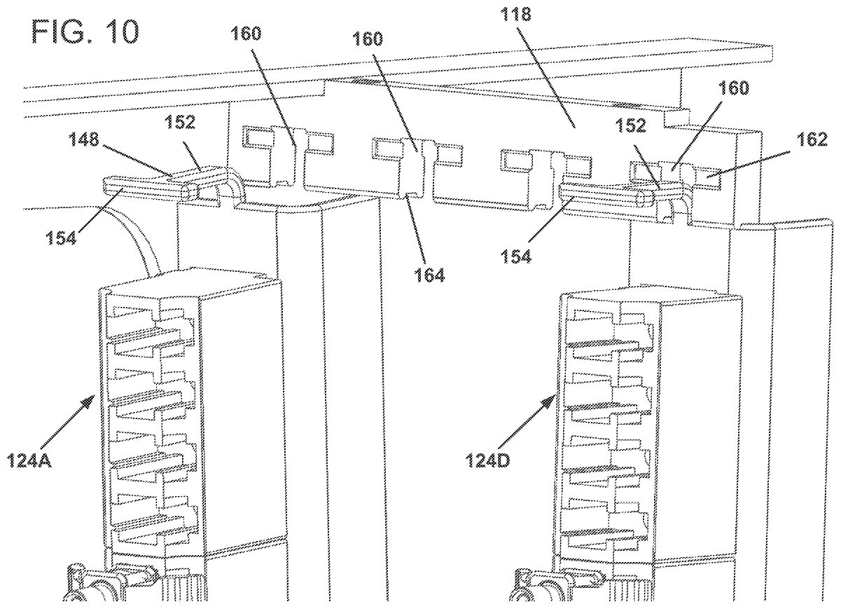

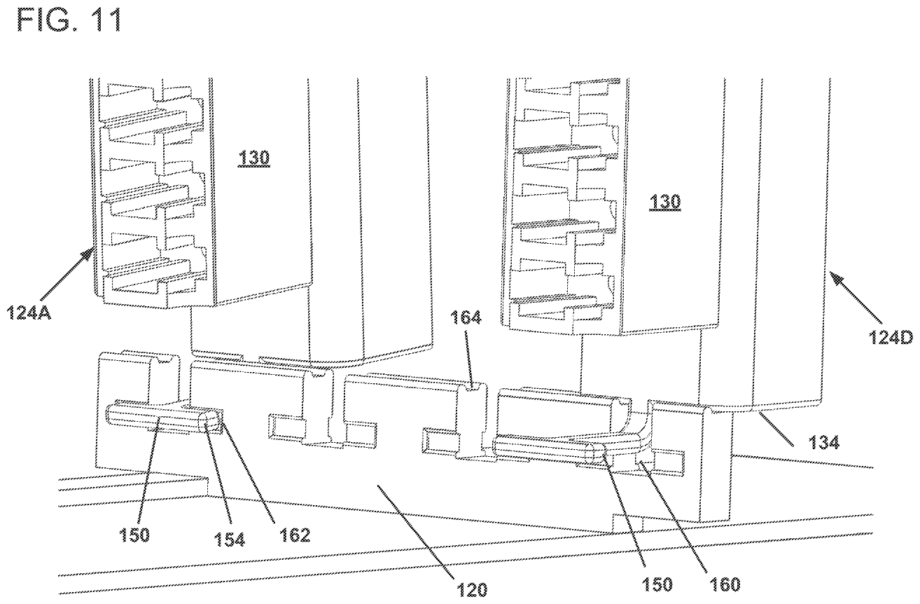

FIGS. 10 and 11 illustrate the interaction between the first and second retainers 148, 150 of the bulkhead members 124 and the first and second retainer strips 118, 120 of the chassis 102. Each retention strip 118, 120 defines a retention surface 164 facing towards the opposite retention strip 120, 118. The retention surface 164 is configured to engage each bulkhead member 124 to releasably hold the bulkhead member 124 in at least the neutral position. In certain examples, the retention surface 164 defines a groove extending parallel with the pivot rod 136. The first end 132 of each bulkhead member 124 is received within the groove 164 of the first retention strip 118 and the second end 134 is received within the groove 164 of the second retention strip 120 via snap-fit connection when the bulkhead member 124 is disposed in the neutral position. The groove 164 is sufficiently deep to retain the bulkhead member 124 against accidental pivoting movement while still allowing pivotal movement upon application of a break-away force.

Each of the retainer strips 118, 120 defines a plurality of stations 160 that are each configured to limit a travel distance of one of the bulkhead members 124 in at least one of the directions D1, D2. In certain examples, each station 160 defines a notch or other aperture through which at least the arm 152 of the respective retainer 148, 150 passes. In certain examples, the cross-member 154 of each retainer 148, 150 is sized to inhibit passage of the cross-member 154 through the station 160, thereby limiting movement of the bulkhead member 124 in one direction. In certain examples, the first retention strip 118 limits pivotal movement of the bulkhead members 124 in the second direction D2 and the second retention strip 120 limits pivotal movement of the bulkhead members 124 in the first direction D1.

For example, FIGS. 10 and 11 illustrate a first bulkhead member 124A disposed in a first angled position and a fourth bulkhead member 124D disposed in a neutral position. When in the neutral position, the first and second retainers 148, 150 of the fourth bulkhead member 124D each have an arm 152 extending through the station 160 so that the cross-member 154 is accessible from the front of the respective retention strip 118, 120. When in the first angled position, the first retainer 148 of the first bulkhead member 124A is disposed forward of the first retention strip 118 and the second retainer 150 extends through the second retention strip 120 from a rear to the front. The cross-member 154 of the second retainer 150 extends across the front of the second retention strip 120 to inhibit further rearward movement of the second end 134 of the first bulkhead member 124A. In certain examples, each station 160 defines a recess 162 sized to receive the cross-member 154 via a friction fit, snap-fit, or other mechanism to retain the first bulkhead 124A in the angled position.

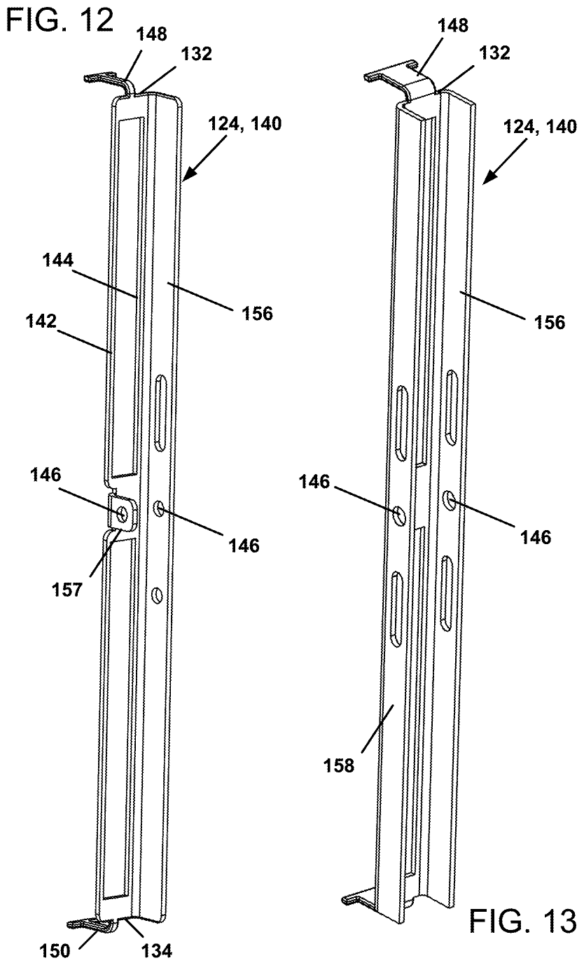

Referring back to FIGS. 8 and 9, in certain implementations, the bulkhead member 124 includes a side flange 156 extending rearwardly from one side of the front surface 144. The side flange 156 defines the pivot aperture 146. In some examples, the bulkhead member 124 includes only one side flange 156. In other examples, the bulkhead member 124 may include a stabilizer tab 157 extending rearwardly from the opposite side of the front surface 144 (e.g., see FIG. 12). The stabilizer tab 157 may define another pivot aperture 146 that aligns with the pivot aperture 146 of the side flange 156. In still other examples, the bulkhead member 124 includes two side flanges 156, 158 extending rearwardly from opposite sides of the front surface 142 (e.g., see FIG. 13). In certain examples, the side flange 158 is identical to the side flange 156. In certain examples, both side flanges 156, 158 extend along a majority of the length L of the bulkhead member 124.

In some implementations, each bulkhead member 124 is configured to pivot independently of the other bulkhead members 124. For example., in FIGS. 3-5, the first bulkhead member 124A pivots between the neutral, first angled, and second angled positions while the second bulkhead member 124B remains in the neutral position. In other implementations, however, the bulkhead members 124 can be configured so that movement of one of the bulkhead members 124 in one pivot direction D1, D2 automatically moves an adjacent one of the bulkhead members 124 in the opposite pivot direction D2, D1. In certain implementations, movement of one of the bulkhead members 124 in one of the pivot directions D1, D2 automatically moves a group of the bulkhead members 124 so that alternate ones of the bulkhead members 124 are moved in opposite pivot directions D1, D2.

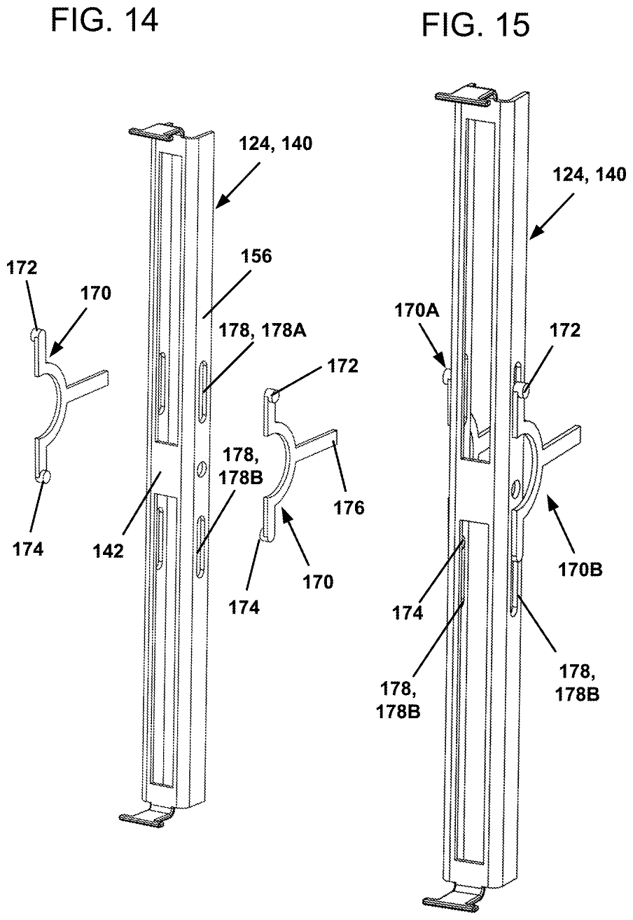

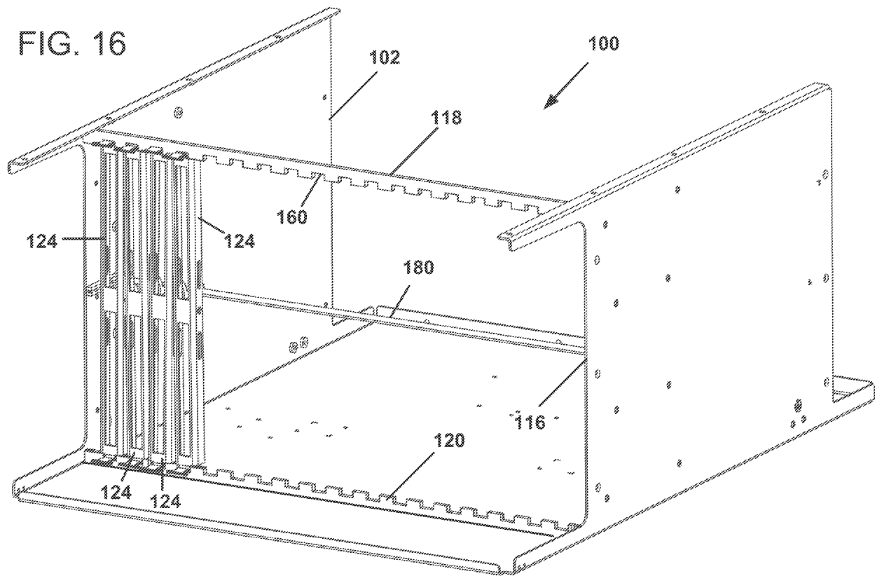

FIGS. 14-18 illustrate an example bulkhead member 124 configured to transfer pivotal motion to one or more other bulkhead members 124 mounted at the chassis 102. Each bulkhead member 124 includes first and second apertures 178A, 178B disposed at opposite ends of the pivot aperture 146. A joining member 170 couples together a pair of adjacent bulkhead members 124 via the apertures 178. Each joining member 170 is mounted so that movement of a first of the bulkhead members 124 of the adjacent pair in one pivot direction D1, D2 automatically moves a second of the bulkhead members 124 of the adjacent pair in an opposite pivot direction D2, D1.

Each joining member 170 includes a first attachment end 172 configured to mount to a first of the bulkhead members 124 in the pair and a second attachment end 174 configured to mount to a second of the bulkhead members 124 of the pair. The joining member 170 is configured so that movement of the first attachment end 172 via pivoting movement of the first bulkhead member 124 automatically moves the second attachment end 174, which transfers the movement to the second bulkhead member 124.

In certain examples, the first attachment end 172 of a joining member 170 faces in an opposite direction than the second attachment end 174. In some examples, the first attachment end 172 faces towards one side 108, 110 of the chassis 102 while the second attachment end 174 faces towards the other side 110, 108 of the chassis 102. Alternatively, if the bulkhead members 124 are configured to pivot about a vertical pivot axis P, then the first attachment end 172 may face towards one of the top 112 and bottom 114 of the chassis 102 and the second attachment end 174 faces towards the other of the top 112 and bottom 114 of the chassis 102.

In some implementations, the apertures 178 are openings sized to fit the respective end 172, 174 of the joining member 170. In such implementations, the joining member 170 rotates relative to the bulkhead member 124 about the respective end 172, 174. In other implementations, one or both of the apertures 178A, 178B are slots (e.g., see FIG. 14) that allow the respective end 172, 174 to slide therealong. Accordingly, the joining member 170 both rotates relative to the bulkhead member 124 and slides along at least a portion of the length L of the bulkhead member 124. In certain examples, one of the apertures 178 is an opening and the other of the apertures 178 is a slot.

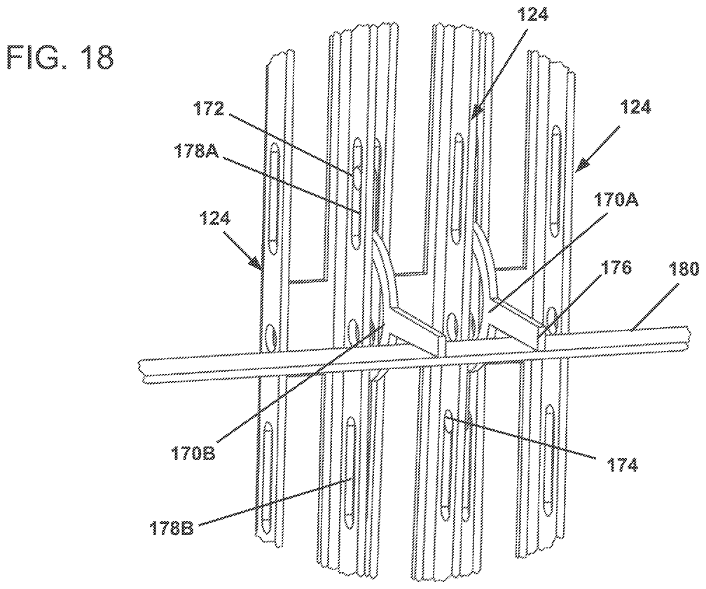

In certain implementations, only one set of the apertures 178A, 178B of each bulkhead member 124 receive attachment ends of a joining member 170. For example, in FIG. 15, the bottom apertures 178B of the bulkhead member 124 receive the second attachment ends 174 of first and second joining members 170A, 170B. The top apertures 178A of the bulkhead member 124 do not receive any portion of the joining members 170A, 170B. Rather, the first attachment end 172 of the first joining member 170A is configured to be received in one of the top apertures 178A of another bulkhead member 124 disposed adjacent the left side of the bulkhead member 124 (e.g., see FIG. 18). The first attachment end 172 of the second joining member 170B is configured to be received in one of the top apertures 178A of another bulkhead member 124 disposed adjacent the right side of the bulkhead member 124 of FIG. 15.

In certain implementations, each joining member 170 includes a third attachment end 176 that is fixed relative to the chassis 102 during pivoting of the bulkhead members 124. In certain examples, the attachment end 176 of each joining member 170 is coupled to an attachment bar 180 that extends across the chassis 102 parallel to the pivot rod 136. Once mounted within the chassis 102, the attachment bar 180 remains stationary relative to the chassis 102. The attachment bar 180 holds the third attachment end 176 of each joining member 170 at a fixed point, which limits the movement of the joining members 170 in response to movement of the bulkhead members 124.

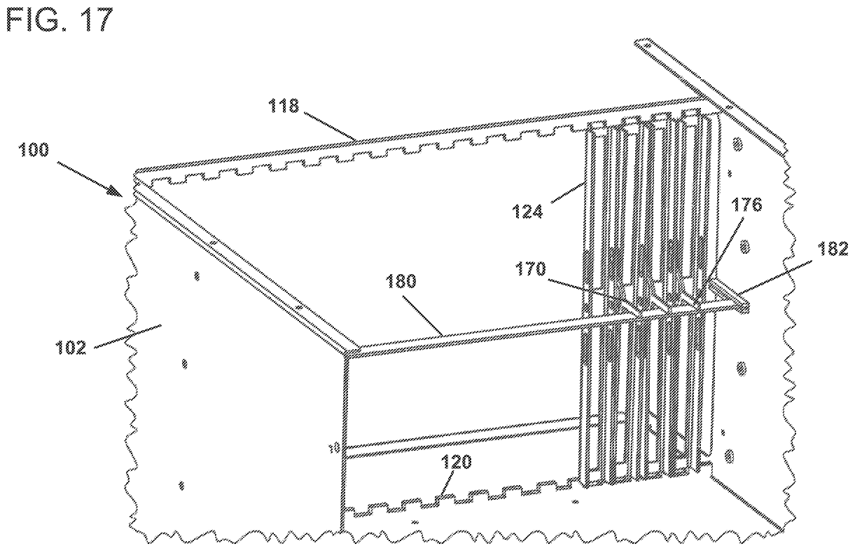

In certain implementations, the attachment bar 180 is slidably mounted within the chassis 102 during assembly of the chassis 102 (e.g., see FIG. 17). For example, mounting guides 182 may be disposed at opposite ends of the chassis 102 (e.g., at the opposite sides 108, 110 when the pivot rod 136 is horizontal or at the top and bottom 112, 114 when the pivot rod 136 is vertical). In some examples, the joining members 170 are monolithically formed or otherwise integrally connected to the attachment bar 180. In other examples, the joining members 170 are restrained by the attachment bar 180 without being integral with the attachment bar 180.

Still referring to FIGS. 14-18, in certain implementations, the bulkhead members 124 are disposed in a row across the framework opening 116 with each bulkhead member 124 extending between the first and second retention strips 118, 120. The bulkhead members 124 include a first set of bulkhead members 124 and a second set of bulkhead members 124. The bulkhead members 124 of the first set alternate with the bulkhead members 124 of the second set as the bulkhead members 124 extend in the row. In certain implementations, movement of a first of the bulkhead members 124 of the first set in one pivot direction D1, D2 automatically moves all of the bulkhead members 124 of the first set in the pivot direction D1, D2. Movement of the first bulkhead member 124 of the first set in one pivot direction D1, D2 automatically moves all of the bulkhead members 124 of the second set in the opposite pivot direction D2, D1. In some examples, the first and second sets of bulkhead members 124 cooperate to fully cover the framework opening 116. In other examples, bulkhead members 124 of one or more sets (or individual bulkhead members) also may be disposed at the framework opening 116.

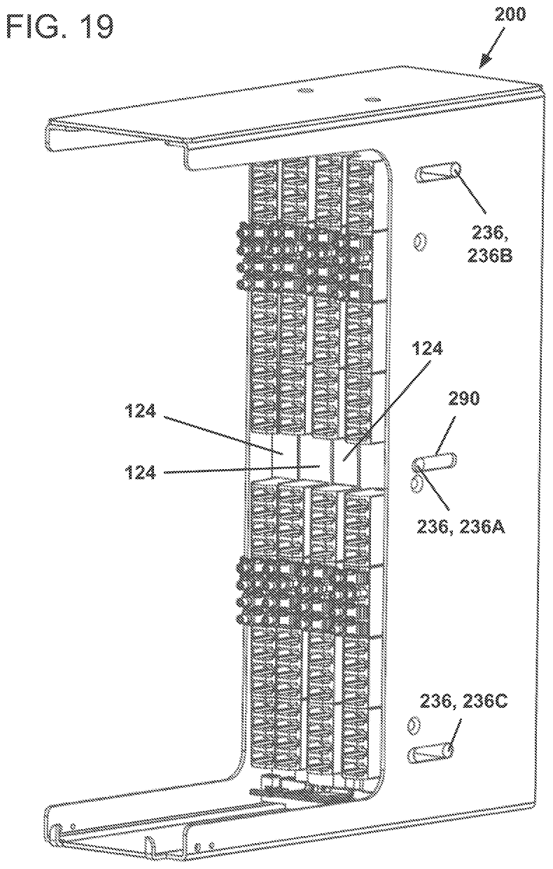

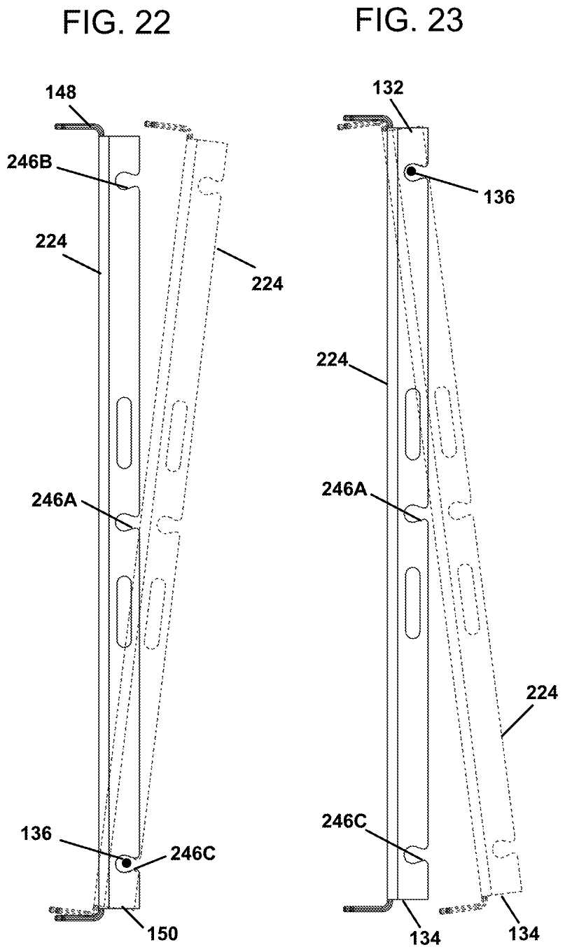

FIGS. 19-26 illustrate another example termination panel 200 including a chassis 202 including first and second retention strips 118, 120 at which one or more bulkhead members 224 can be mounted. The termination panel 200 is substantially the same as the termination panel 100 except that the chassis 202 supports multiple pivot rods 236 about which bulkhead members 224 may pivot. In some examples, the pivot rods 236 extend horizontally and are spaced apart along the height H of the chassis 202. In other examples, the pivot rods 236 extend vertically and are spaced apart along the width W of the chassis 202.

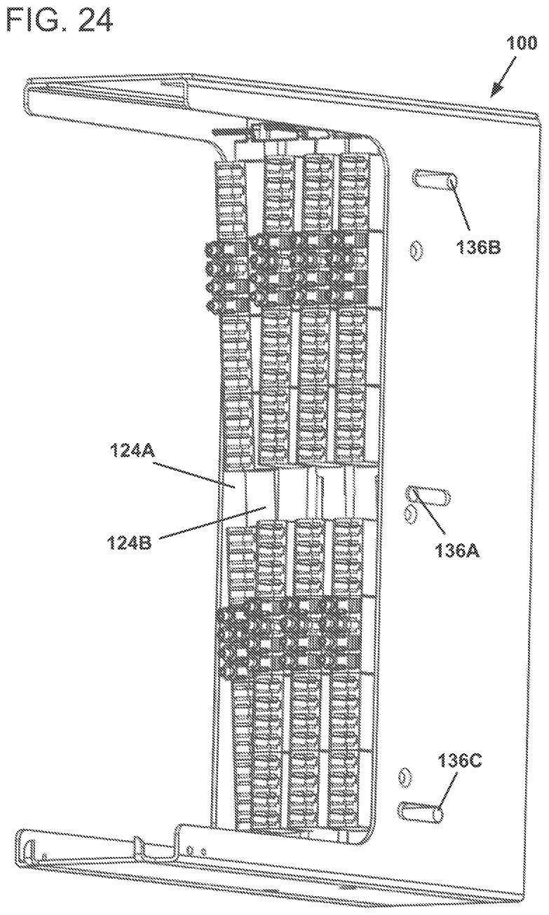

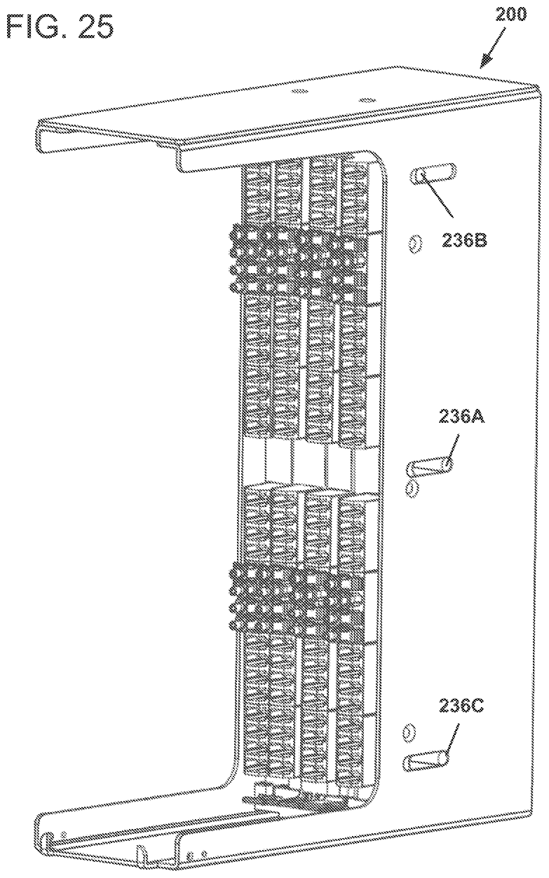

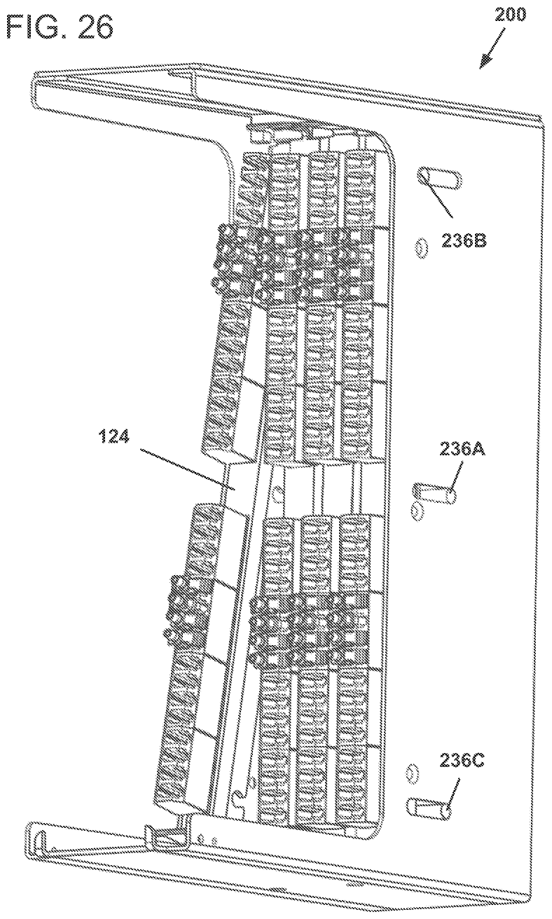

Each of the pivot rods 236 is movable relative to the chassis 202 between a retracted position and an extended position. For example, in certain implementations, the pivot rods 236 are configured to slide relative to the chassis 202 between the retracted and extended positions. The bulkhead members 224 are configured to pivot about a pivot rod 236 disposed in the extended position. In FIGS. 19 and 24, the middle pivot rod 236A is disposed in the extended position (e.g., visible through slot 290) and the top and bottom pivot rods 236B, 236C are disposed in the retracted position. In FIGS. 25 and 26, the top pivot rod 236B is disposed in the extended position and the middle and bottom pivot rods 236A, 236C are disposed in the retracted positions.

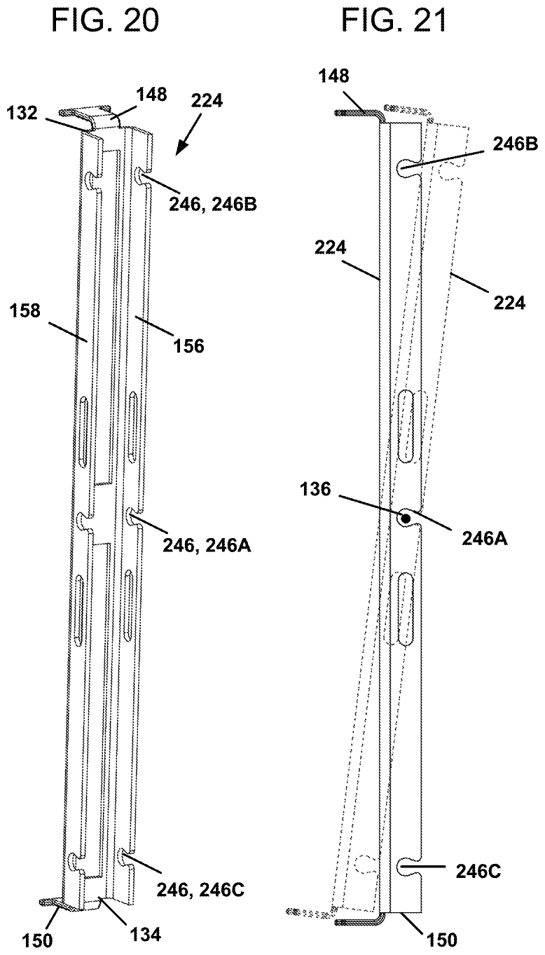

As shown in FIGS. 20-23, the bulkhead member 224 is the same as the bulkhead member 124 of FIG. 13, except that the bulkhead member 224 defines multiple pivot apertures 246 spaced apart along the length L of the bulkhead member 224. Each of the pivot apertures 246 aligns with one of the pivot rods 236 when the bulkhead member 224 is mounted at the framework opening 116 of the chassis 202. In the example shown, the bulkhead member 246 includes a first pivot notch 246A disposed at an intermediate location (e.g., a center) along the length, a second pivot notch 246B disposed at the first end 132 of the bulkhead member 224, and a third pivot notch 246C disposed at the second end 134 of the bulkhead member 224.

Further, each of the pivot apertures 246 defines an open-ended notch instead of a closed hole. Accordingly, a pivot rod 236 can be slid into and out of the pivot notches 246 at a discretion of the user. The pivot rods 236 are configured to engage the bulkhead member 224 at the aligned pivot apertures 246 when in the extended position and to disengage from the bulkhead member 224 when in the retracted position. For example, the pivot rod 236 may snap-fit into and out of the corresponding pivot notch 246.

In certain implementations, the termination panel includes a top pivot rod 236B and a bottom pivot rod 236C, but does not include a middle pivot rod 236A. In such examples, the bulkhead members 224 may pivot about either end 132, 134. In certain examples, the top and bottom pivot rods 236B, 236C are not movable relative to the chassis 202. Rather, each bulkhead member 224 engages both pivot rods 236B, 236C when disposed in the neutral position and disengages one of the pivot rods 236B, 236C to pivot about the other pivot rod 236B, 236C.

### ASPECTS

1. A termination panel comprising:
a plurality of bulkhead members, each bulkhead member having a front surface extending along a length between opposite first and second ends, each front surface carrying a plurality of front ports, each bulkhead member defining a pivot aperture at an intermediate location along the length, and each bulkhead member including a first retainer at the first end and a second retainer at the second end;
a chassis having a depth extending between a front and a rear, a width extending between opposite first and second sides, and a height extending between a top and a bottom, the chassis defining an access opening bounded by oppositely facing first and second retainer strips, the first retainer strip defining a plurality of first stations, each first station being configured to limit a travel distance of the first end of a respective one of the bulkhead members in a first pivot direction, the second retainer strip being configured to limit a travel distance of the second end of a respective one of the bulkhead member in a second pivot direction that is opposite the first pivot direction; and
a pivot pin extending across the chassis, the pivot pin sized to fit within the pivot aperture of each bulkhead member so that each bulkhead member pivots about the pivot pin relative to the chassis.
   2. The termination panel of aspect 1, wherein the pivot pin extends between the first and second sides at an intermediate location along the height between the top and the bottom; and wherein the first and second retainers are disposed at the top and bottom at the access opening.
   3. The termination panel of aspect 1, wherein the pivot pin extends between the top and bottom at an intermediate location along the width between the first and second sides of the chassis; wherein the first and second retainers are disposed at the first and second sides at the access opening.
   4. The termination panel of any of aspects 1-3, wherein each of the bulkhead members is configured to pivot from a neutral position to a first angled position.
   5. The termination panel of aspect 4, wherein each of the bulkhead members is configured to pivot from the neutral position to a second angled position.
   6. The termination panel of any of aspects 1-5, wherein the front surface of each bulkhead member defines first and second port mounting openings disposed at opposite sides of the respective pivot aperture of the bulkhead member.
   7. The termination panel of any of aspects 1-6, wherein each first station of first retainer strip and each second station of the second retainer strip defines a recess configured to receive the first retainer of a respective one of the bulkhead members in a snap-fit connection.
   8. The termination panel of any of aspects 1-7, wherein each bulkhead member includes a first handle at the first end and a second handle at the second end, each of the first and second handles extending forwardly of the front surface.
   9. The termination panel of aspect 8, wherein the first retainer strip defines a plurality of first notches through which the first handles pass when the bulkhead members pivot; and wherein the second retainer strip defines a plurality of second notches through which the second handles pass when the bulkhead members pivot.
   10. The termination panel of aspect 9, wherein the first and second handles are each T-shaped.
   11. The termination panel of aspect 9, wherein the first retainer strip defines a forward-facing recess at each first notch, each forward-facing recess being configured to receive a portion of the respective first handle when the respective bulkhead member is disposed in a top back position; and wherein the second retainer strip defines a forward-facing recess at each second notch, each forward-facing recess being configured to receive a portion of the respective second handle when the respective bulkhead member is disposed in a top forward position.
   12. The termination panel of any of aspects 1-11, wherein each bulkhead member includes a side flange extending rearwardly from the front surface.
   13. The termination panel of aspect 12, wherein the side flange is a first side flange; and wherein a first of the bulkhead members includes a second side flange extending rearwardly from the front surface at an opposite side of the bulkhead member from the first side flange.
   14. The termination panel of aspect 13, wherein the second side flange extends fully along the length of the front surface.
   15. The termination panel of any of aspects 1-14, wherein each bulkhead member is configured to pivot independently.
   16. The termination panel of any of aspects 1-14, wherein the bulkhead members are configured so that movement of one of the bulkhead members in a first pivot direction automatically moves an adjacent one of the bulkhead members in an opposite second pivot direction.
   17. The termination panel of aspect 16, wherein the bulkhead members include a first set of bulkhead members and a second set of bulkhead members, the bulkhead members of the first set alternating with the bulkhead members of the second set as the bulkhead members are disposed in a row extending along the first and second retainer strips; and wherein movement of one of the bulkhead members of the first set in the first pivot direction automatically moves all of the bulkhead members of the first set in the first pivot direction.
   18. The termination panel of aspect 17, wherein movement of one of the bulkhead members of the first set in the first pivot direction automatically moves all of the bulkhead members of the second set in the second pivot direction.
   19. The termination panel of any of aspects 1-11, further comprising a joining member disposed between an adjacent pair of the bulkhead members, the joining member being mounted to the adjacent pair of the bulkhead members so that movement of a first of the bulkhead members of the adjacent pair in a first pivot direction automatically moves a second of the bulkhead members of the adjacent pair in a second pivot direction.
   20. The termination panel of aspect 19, wherein each bulkhead member includes first and second side flanges extending rearwardly from the front surface, each of the first and second side flanges defining first and second apertures disposed at opposite sides of the respective pivot aperture; and wherein the joining member includes a first attachment end that fits in the first aperture of the second side flange of the first bulkhead member of the adjacent pair and the joining member includes a second attachment end that fits in the second aperture of the first side flange of the second bulkhead member of the adjacent pair.
   21. The termination panel of aspect 20, wherein the joining member is a first joining member; and wherein a second joining member includes a first attachment end that faces in an opposite direction from the first attachment end of the first joining member and the second joining member includes a second attachment end that fits in the second aperture of the second side flange of the second bulkhead member of the adjacent pair.
   22. The termination panel of aspect 21, further comprising a third bulkhead member adjacent the second bulkhead member, the third bulkhead member including first and second side flanges each defining first and second apertures disposed at opposite sides of the respective pivot aperture, wherein the first attachment end of the second joining member fits in the first aperture of the first side flange of the third bulkhead member.
   23. The termination panel of any of aspects 20-22, wherein the first and second apertures define slots that are elongate along the length of the respective bulkhead member, wherein the attachment ends of each joining member are configured to slide along the slots.
   24. The termination panel of any of aspects 19-23, wherein the joining member is one of a plurality of joining members, and wherein each joining member is retained at a fixed position along the height of the chassis while being able to move along a forward-rearward axis of the chassis.
   25. The termination panel of aspect 24, wherein the joining members attach to a lateral bar that extends across the chassis between the first and second sides, the lateral bar being slidably mounted to the chassis so that the lateral bar slides along the forward-rearward axis.
   26. The termination panel of any of aspects 1-25, wherein the pivot aperture of each bulkhead member is a first notch, wherein each bulkhead member defines a second notch at the first end and a third notch at the second end; and wherein the pivot pin is a first pivot pin that is movable relative to the chassis along a forward-rearward axis of the chassis.
   27. The termination panel of aspect 26, further comprising:
a second pivot pin extending across the chassis at a location offset from the first pivot pin in a first direction, the second pivot pin being sized to fit within the second notch of each bulkhead member, the second pivot pin being movable relative to the chassis along the forward-rearward axis of the chassis; and
a third pivot pin extending across the chassis at a location offset from the first pivot pin in a second direction opposite the first direction, the third pivot pin being sized to fit within the third notch of each bulkhead member, the third pivot pin being movable relative to the chassis along the forward-rearward axis of the chassis.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A termination panel comprising:
a plurality of bulkhead members, each bulkhead member having a front surface extending along a length between opposite first and second ends, each front surface carrying a plurality of front ports, each bulkhead member defining a pivot aperture at an intermediate location along the length, and each bulkhead member including a first retainer at the first end and a second retainer at the second end;
a chassis having a depth extending between a front and a rear, a width extending between opposite first and second sides, and a height extending between a top and a bottom, the chassis defining an access opening bounded by oppositely facing first and second retainer strips, the first retainer strip defining a plurality of first stations, each first station being configured to limit a travel distance of the first end of a respective one of the bulkhead members in a first pivot direction, the second retainer strip being configured to limit a travel distance of the second end of a respective one of the bulkhead member in a second pivot direction that is opposite the first pivot direction; and
a pivot pin extending across the chassis, the pivot pin sized to fit within the pivot aperture of each bulkhead member so that each bulkhead member pivots about the pivot pin relative to the chassis.

2. The termination panel of claim 1, wherein the pivot pin extends between the first and second sides at an intermediate location along the height between the top and the bottom; and wherein the first and second retainers are disposed at the top and bottom at the access opening.

3. The termination panel of claim 1, wherein the pivot pin extends between the top and bottom at an intermediate location along the width between the first and second sides of the chassis; wherein the first and second retainers are disposed at the first and second sides at the access opening.

4. The termination panel of claim 1, wherein each of the bulkhead members is configured to pivot from a neutral position to a first angled position.

5. The termination panel of claim 4, wherein each of the bulkhead members is configured to pivot from the neutral position to a second angled position.

6. The termination panel of claim 1, wherein the front surface of each bulkhead member defines first and second port mounting openings disposed at opposite sides of the respective pivot aperture of the bulkhead member.

7. The termination panel of claim 1, wherein each first station of first retainer strip and each second station of the second retainer strip defines a recess configured to receive the first retainer of a respective one of the bulkhead members in a snap-fit connection.

8. The termination panel of claim 1, wherein each bulkhead member includes a first handle at the first end and a second handle at the second end, each of the first and second handles extending forwardly of the front surface, wherein the first retainer strip defines a plurality of first notches through which the first handles pass when the bulkhead members pivot; and wherein the second retainer strip defines a plurality of second notches through which the second handles pass when the bulkhead members pivot.

9. The termination panel of claim 1, wherein each bulkhead member includes a side flange extending rearwardly from the front surface, wherein the side flange is a first side flange; and wherein a first of the bulkhead members includes a second side flange extending rearwardly from the front surface at an opposite side of the bulkhead member from the first side flange.

10. The termination panel of claim 9, wherein the second side flange extends fully along the length of the front surface.

11. The termination panel of claim 1, wherein each bulkhead member is configured to pivot independently.

12. The termination panel of claim 1, wherein the bulkhead members are configured so that movement of one of the bulkhead members in a first pivot direction automatically moves an adjacent one of the bulkhead members in an opposite second pivot direction.

13. The termination panel of claim 12, wherein the bulkhead members include a first set of bulkhead members and a second set of bulkhead members, the bulkhead members of the first set alternating with the bulkhead members of the second set as the bulkhead members are disposed in a row extending along the first and second retainer strips; and wherein movement of one of the bulkhead members of the first set in the first pivot direction automatically moves all of the bulkhead members of the first set in the first pivot direction.

14. The termination panel of claim 13, wherein movement of one of the bulkhead members of the first set in the first pivot direction automatically moves all of the bulkhead members of the second set in the second pivot direction.

15. The termination panel of claim 1, further comprising a joining member disposed between an adjacent pair of the bulkhead members, the joining member being mounted to the adjacent pair of the bulkhead members so that movement of a first of the bulkhead members of the adjacent pair in a first pivot direction automatically moves a second of the bulkhead members of the adjacent pair in a second pivot direction.

16. The termination panel of claim 15, wherein each bulkhead member includes first and second side flanges extending rearwardly from the front surface, each of the first and second side flanges defining first and second apertures disposed at opposite sides of the respective pivot aperture; and wherein the joining member includes a first attachment end that fits in the first aperture of the second side flange of the first bulkhead member of the adjacent pair and the joining member includes a second attachment end that fits in the second aperture of the first side flange of the second bulkhead member of the adjacent pair.

17. The termination panel of claim 16, wherein the joining member is a first joining member; and wherein a second joining member includes a first attachment end that faces in an opposite direction from the first attachment end of the first joining member and the second joining member includes a second attachment end that fits in the second aperture of the second side flange of the second bulkhead member of the adjacent pair.

18. The termination panel of claim 17, further comprising a third bulkhead member adjacent the second bulkhead member, the third bulkhead member including first and second side flanges each defining first and second apertures disposed at opposite sides of the respective pivot aperture, wherein the first attachment end of the second joining member fits in the first aperture of the first side flange of the third bulkhead member.

19. The termination panel of any of claims 16, wherein the joining member is one of a plurality of joining members, and wherein each joining member is retained at a fixed position along the height of the chassis while being able to move along a forward-rearward axis of the chassis, wherein the joining members attach to a lateral bar that extends across the chassis between the first and second sides, the lateral bar being slidably mounted to the chassis so that the lateral bar slides along the forward-rearward axis.

20. The termination panel of claim 1, wherein the pivot aperture of each bulkhead member is a first notch, wherein each bulkhead member defines a second notch at the first end and a third notch at the second end; and wherein the pivot pin is a first pivot pin that is movable relative to the chassis along a forward-rearward axis of the chassis.
